(19) United States
(12) Patent Application Publication
(10) Pub. No.: US 2001/0039501 A1
(43) Pub. Date: Nov. 8, 2001

(54) Method for supplying management services from a service centre for a plurality of industrial cleaning processes or machines and system for monitoring a plurality of industrial cleaning processes or machine

(75) Inventors: Jan Willem Crevel, Utrecht (NL); Marcellus Gerardus Dusamos, Maarssen (NL); James Wesley Livingston, Santa Cruz, CA (US); Leendert Los, Maarssen (NL); Pieter Luijendijk, Maarssen (NL); Hubert Pierre Ten Voorden, Maarssen (NL)

Correspondence Address: UNILEVER, PATENT DEPARTMENT, 45 RIVER ROAD, EDGEWATER, NJ, 07020, US

(73) Assignee: Diversey Lever, Inc.

(21) Appl. No.: 09/841,839

(22) Filed: Apr. 25, 2001

(30) Foreign Application Priority Data
Apr. 25, 2000 (EP) 00201463.7

(51) Int. Cl. G06F 17/60

(52) U.S. Cl. 705/1

(57) ABSTRACT

A method is described for supplying management services from a service center for a plurality of industrial cleaning processes or machines at remote sites and/or operated by different organizations. A local unit is provided at each process or machine, which is programmed to forward process/machine information with a process/machine identification to the service center. The information received from the local units is processed in a service center computer to obtain management reports on the process or operation of the machines. In a system for monitoring a plurality of industrial cleaning processes or machines operated by at least one organization, each process or machine uses a local unit with a plurality of sensors for sensing operating parameters of the process or machine. The sensors provide parameter dependent signals to the local unit and the local unit stores the operating parameter data. A service center computer operated by a service organization at a location remote from the location(s) of the local units is programmed to make a connection to a local unit and to obtain operating parameter data from the local unit periodically. The service center computer is programmed to provide reports with operating parameter data of at least one process or machine against reference operating parameter data.

The present invention relates to a method for supplying management services from a service centre for a plurality of industrial cleaning processes or machines at remote sites and/or operated by different organisations, and to a system for monitoring a plurality of industrial cleaning processes or machines operated by at least one organisation, each process or machine using a local unit with a plurality of sensors for sensing operating parameters of the process or machine, the sensors providing parameter dependent signals to the local unit, wherein the local unit stores the operating parameter data. Systems of this type can be used for example in the field of ware washing, laundries, bottle washing, floor cleaning, track treatment. The prior art systems are used as a data logger, wherein it is assumed that machine operators regularly check the data obtained on correct operation of the process or machine. Practice has shown that the machine operators do not pay sufficient attention to the data provided by the data logger so that the process or machine may operate for relatively long periods with operating parameters which do not meet the requirements. Moreover, it is difficult to analyse the data obtained in this manner.

EP-A-0 630 202 (or corresponding U.S. Pat. Nos. 5,404,893 and 5,556,478) discloses a system for controlling the detergent concentration in a warewashing machine, comprising a sensor for measuring a detergent concentration level. Further a detergent concentration set-point value can be set and the system controls the detergent feed to meet the set-point value. Just as with the data logging systems, the machine operators are assumed to set a correct set-point value and to check the correct operation of the system.

U.S. Pat. No. 5,681,400 discloses a system for controlling an additive concentration in a warewashing machine functioning in the same manner as the system of the above-mentioned US patents. Again the machine operators are assumed to set a correct set-point value and to check the correct operation of the system.

It is an object of the invention to provide a method of the above-mentioned type, which can be used to improve industrial cleaning processes or the operation of industrial cleaning machines.

A further object of the invention is to provide a system of the above-mentioned type, by means of which the processes or operation of the machines can be improved.

According to the invention a method is provided characterized by providing a local unit at each process or machine, said local unit being programmed to forward process/machine information with a process/machine identification to the service centre, processing the information received from the local units in a service centre computer to obtain management reports on the process or operation of the machines.

According to the invention the system is characterized by a service centre computer operated by a service organisation at a location remote from the location(s) of the local units, wherein the service centre computer is programmed to make a connection to a local unit and to obtain operating parameter data from the local unit periodically, wherein the service centre computer is programmed to provide reports with operating parameter data of at least one process or machine against reference operating parameter data.

In this manner a method and system are obtained, wherein by compiling operating data at a centre location, key performance indicators can be produced by comparison of the operating parameter data against standard operating parameter data or averaged data, for example. In this manner management can use the reports to motivate the machine operators as the results of their activities can be made visible in an easy manner.

The system of the invention can be used in an embodiment with processes or machines located at different sites and/or operated by at least two organisations, wherein according to the invention the local units are programmed to connect to the service centre computer, wherein the service centre computer is programmed to provide reports with operating parameter data of processes or machines of the same organisation. In this manner any organization is able to use the service centre computer to obtain information on optimal operation of their processes or machines.

The invention will be further explained by reference to the drawings in which an embodiment of the system of the invention is shown as used by way of example for monitoring ware washing operations. However it will be understood that the method and system of the invention can be advantageously used in other industrial cleaning processes or machines, such as processes and machines in the field of for example ware washing, laundry, bottle washing, floor cleaning and track treatment.

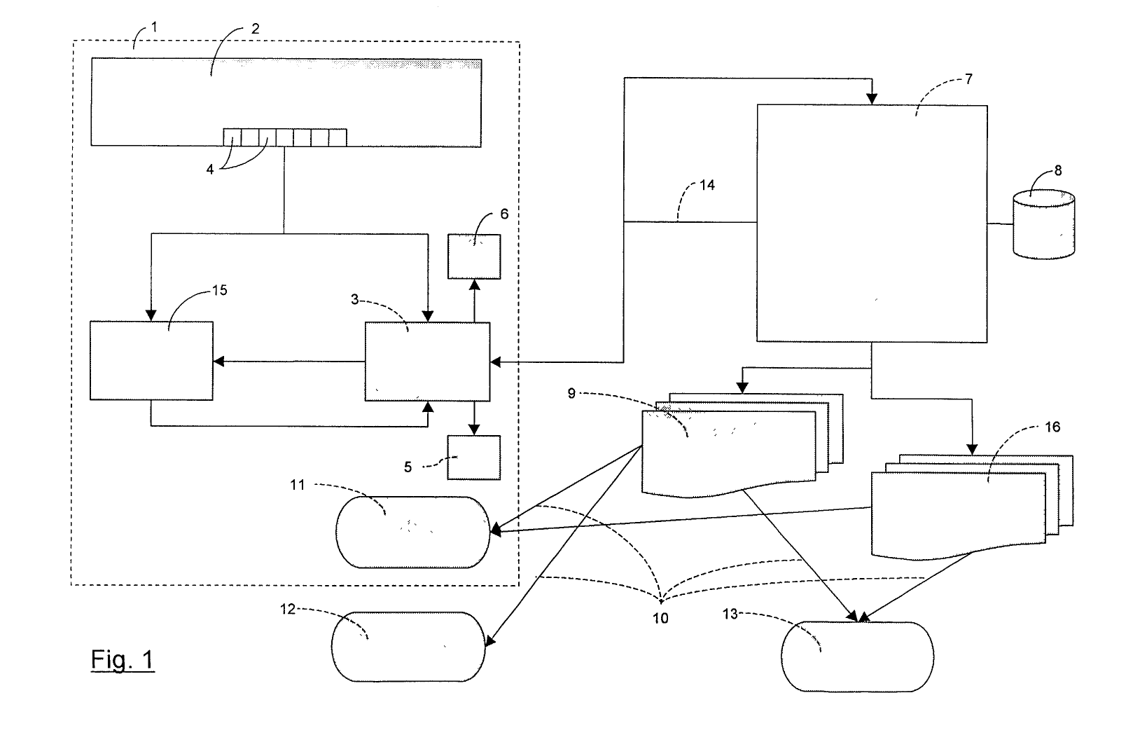

FIG. 1 schematically shows an embodiment of the system described.

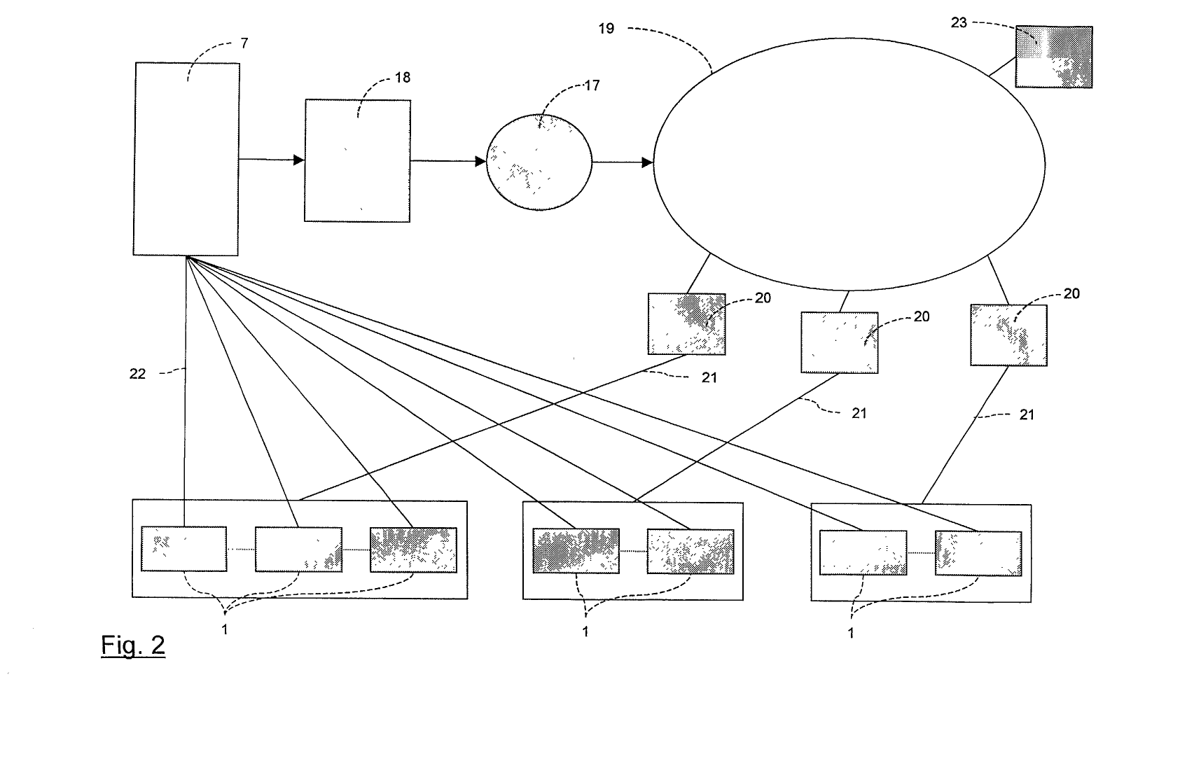

FIG. 2 shows an embodiment of the system, wherein a network such as the internet is used to allow clients to access reports on their cleaning processes or machines.

For the sake of clarity only one local ware washing operation is schematically shown in FIG. 1, whereas in practice a number of local operations can be serviced by one service centre. The local ware washing system or operation schematically indicated by a dashed line 1, comprises a ware washing machine 2 and a system for monitoring the operation of the ware washing machine 2. This system comprises a processing unit 3 and a plurality of sensors 4 for sensing operating parameters of the ware washing machine or process. These parameters include for example conductivity, rinse trigger, wash trigger, pre-wash temperature, main wash temperature, rinse temperature, fill valve open/close, low-level switch, fill water flow, rinse water flow, etc. Each sensor 4 provides a signal dependent on one of these parameters to the processing unit 3.

In order to improve the operation of the cleaning process, it is an important aspect to signal any alarm situations in the cleaning process at an early stage. To this end, the processing unit 3 is programmed with a number of algorithms to monitor the parameter dependent signals received from the sensors 4. Some of these algorithms use as input signals the signals of sensors 4 dependent on several important temperatures in the cleaning process, such as the above-mentioned pre-wash temperature and main wash temperature. If the temperature is too low, the processing unit 3 will generate an alarm message. Further important algorithms for signaling possible alarm situations at an early stage involve the use of a set of at least two sensors 4 sensing mutual dependent parameters of the cleaning process. The processing unit 3 is programmed with algorithms using as input signals the parameter dependent signals of such sets of sensors 4, wherein the algorithm comprises an alarm setting for one or both of the input signals. The alarm setting is activated by an input signal and the processing unit 3 generates an alarm message if the input signal matches the alarm signal. By way of example a sensor 4 could sense the switching on/off of a heater element, whereas a second sensor 4 is a temperature sensor. The alarm setting of the corresponding algorithm could be a lack of temperature increase within a predetermined period after switching on the heater element.

As further examples of pairs of sensors sensing mutual dependent parameters can be mentioned a sensor sensing switching on/off a detergent feed pump and a sensor sensing the detergent concentration level of the washing solution; a sensor sensing the position of a water valve and a sensor sensing the water level in a tank.

More particularly, an alarm situation is for example a failing fill flow. Fill flow is the water flow to fill the tanks of the ware washing machine 2 and to keep the tanks at the required level during the washing operation. A fill flow is obtained by opening a fill valve. Generally, the fill valve is a valve operated by a solenoid. This algorithm uses input signals from a sensor 4 providing a fill trigger signal, i.e. an electrical signal caused by energising the fill valve solenoid, and a sensor 4 providing a fill flow signal. The fill trigger signal activates an alarm setting for the threshold value of the flow signal. The flow threshold set is for example 3 l/min. If this flow threshold is not exceeded within a specific period of for example 120 seconds after receipt of the fill trigger signal, an alarm message is generated by the processing unit 3.

A further example of an algorithm using the parameter dependent signals of a set of sensors is an algorithm for detecting a low fill flow. This algorithm uses the same sensors 4 as the no fill flow algorithm, wherein in this case the flow threshold is set at for example 20 l/min. If within a time period of for example 300 seconds after receipt of the fill trigger signal the flow signal does not exceed the flow threshold of 20 l/min. an alarm message will be generated by the processing unit 3.

Further examples of such algorithms are algorithms for detecting a low rinse flow and a high rinse flow, respectively. These two algorithms use the same two sensors providing a rinse trigger signal and a rinse flow signal, respectively. The rinse flow is the water flow in the ware washing machine 2 for the rinse in the last section of the machine. A rinse flow is obtained by opening a rinse valve. Generally, the rinse valve is a valve operated by a solenoid. The rinse trigger signal is an electrical signal caused by energising the rinse valve solenoid.

As further algorithms for the monitoring system can be mentioned an algorithm for detecting high water consumption during fill, i.e. from the end of a drain until the wash pump is switched on, an algorithm for detecting high water consumption during washing, an algorithm for detecting rinse before the ware washing machine is filled with fresh water, an algorithm to detect the start of washing before the main wash temperature has been reached, etc. In summary, using a set of at least two sensors sensing mutual dependent parameters provides for a system allowing an accurate monitoring of the ware washing process. In combination with monitoring a time dependency of an input signal the system described can provide further detailed information on the ware washing process. For measuring time dependency a timer means 5 can be used providing a time signal to the processing unit 3. As an example of an algorithm wherein an alarm setting is used dependent on the time dependency of an input signal, the processing unit 3 can be programmed with an algorithm to monitor whether sufficient refreshments of the washing tank content are carried out. This algorithm uses time windows, wherein within these windows the algorithm uses a sensor signal indicating active wash time, i.e. rinse on, which means rinse valve open, and wash on, which means that the wash pumps are running. As known the wash pumps circulate water from the tanks across the ware. If in a first time window the active washing time is less than 70%, nothing happens. In case within the first time window the active washing time is more than 70%, a second time window is started, within which a signal should be received indicating a drain of the washing tanks, i.e. a complete emptying of the tanks by opening a drain valve in the bottom of the tanks. If this drain signal is received, no alarm signal will be given. In case no drain signal is received within the second time window, the algorithm generates an alarm message. Time dependency can also be used to monitor the rate of change of a sensor signal. In such a case the time signal is actually used as one of the input signals of the algorithm.

If one of the algorithms of the processing unit 3 generates an alarm message, the processing unit can actuate an alarm signaling device 6 so that a machine operator can take appropriate action. However, an operator having detailed knowledge of the cleaning process may not be available, so that appropriate action will not always be taken as soon as possible or in case of a relatively complicated problem can never be taken by a machine operator.

In the preferred embodiment shown this problem is overcome in that the processing unit 3 generates an alarm message including a machine identification, an alarm identification and time/date of occurrence of the alarm message. The processing unit 3 makes a connection, for example through a telephone line, to a service centre computer 7 and forwards the complete alarm message to the service centre computer 7. At the location of the service centre computer 7, i.e. at a service centre, the organisation operating the service centre can guarantee that a high level of knowledge will always be available to take appropriate action on any alarm message received.

Preferably, the service centre computer 7 comprises a database 8 containing contact information with corresponding machine identifications. The machine identification of an alarm message is used to forward maintenance information or incident messages 9 to the contact in accordance with the contact information stored with the corresponding machine identification. In this manner, the appropriate person or organisation is informed as soon as possible on the incident occurred. Depending on the type of incident message, an operator working at the service centre may use the alarm message to call a machine operator of the ware washing machine 2 from which the alarm message was received to inform this machine operator on the action he should take. The alarm message could be provided to service employees of the service centre, so that they are warned to go to the location of the respective ware washing machine. Further, if the alarm message indicates failure of the washing machine, employees of the supplier of the machine can be informed accordingly. The alarm messages can be forwarded to an employee in any suitable manner, for example by telephone, fax or e-mail. In summary, the information in the database 8 allows the service centre computer 7 to automatically issue a message using the appropriate contact details so that the incident information is directly forwarded to the person capable of addressing the corresponding alarm situation. In this manner the problem will be resolved more quickly, whereas other persons not able to solve the problem, will not be disturbed. The persons to be contacted can be part of the organisation operating the ware washing machine, part of the organisation of the service centre or any other organisation. Several possibilities for forwarding incident messages 9 are schematically indicated in FIG. 1 by arrows 10 together with contacts 11, 12, and 13 at the local site, the head office, and a supplier, respectively. It will be clear that the process of routing the alarm messages to the correct persons, organisations can be tailored in an easy manner to meet the requirements of the organisations using the system described.

The service centre computer 7 can be programmed to provide a further warning alarm to specific contacts of the organisation operating the local ware washing process in case an alarm is not being resolved within a specified time.

In case an alarm has been lifted due to proper action of a machine operator or in any other manner, the processing unit 3 will make a connection to the service centre computer 7 to inform the computer 7 accordingly. A message “alarm cancelled” is forwarded to the computer 7. The service centre computer 7 can be programmed to inform the corresponding contact accordingly, so that unnecessary visits of employees to the location of the washing machine 2 can be prevented.

Depending on the type of alarm message, the service centre computer 7 can be programmed to send a control signal or command via a connection 14 to the processing unit 3 to change a set point of any operating device for controlling the operation of the ware washing machine. For example, the processing unit 3 can be adapted to set dosing set points, dosing modes, etc. of detergent dosing pumps 15 of the ware washing machine 2. In this manner the service centre computer 7 can provide commands to the processing unit 3 to actuate the dosing pumps to correct the alarm situation. Of course, the processing unit can be adapted to control other operating devices of the ware washing machine 2.

In the preferred embodiment shown, the possibility of making a connection between the service centre computer 7 and the processing units 3 of all local systems 1, is advantageously used to record process or operating parameter data of the washing operation in the database 8 of the service centre computer 7. The process data can be used to generate reports 16 on the cleaning operation. As explained above a number of sensors 4 is provided for each ware washing machine 2, so that a large amount of process data is available at each processing unit 3. The process data is used by the service centre computer 7 to generate management reports. Such reports can be summary and exception reports, which will help managers of ware washing operations to manage by exception. Further, such reports can advantageously be used to focus attention of the staff operating the washing machines to relatively poor performance or to motivate the staff for relatively good performance. The “head-office” of organisations managing large ware washing operations are able to do comparative analysis on their local ware washing operations as to equipment, procedures, lay-out, etc. Such analysis provides for example the possibility to apply “a best mode of operation” at all local ware washing operations. Machines, sites, machine operator shifts, and local managers can be involved in such comparisons so that successful methods used at one site can be implemented at other sites.

Preferably, the process or operating parameter data is reported against reference parameter data. Key performance indicators are reported against targets, norms or averages to allow easy interpretation. The reference values can be determined by the service centre on the basis of their know-how. The reports can provide information on the process data in the form of a percentage above/below the reference target data. Further, if desired, the customers can be provided with expert advice on their cleaning operations.

It is noted that the reference target data can for example be obtained by processing the data received from the local processing units.

The service centre computer 7 can further be programmed to provide hygiene reports with details that meet local requirements for such reports. Such hygiene reports include for example key parameters, such as water temperatures in pre-wash, main wash and final rinse section. Further critical parameters for hygiene reports are detergent concentration in wash tank, time interval during which ware is in contact with the wash liquor and final rinse flow. Such hygiene reports allow organisations of ware washing operations to provide batch hygiene reports to their customers showing the quality of the services provided.

The reports 16 can be issued by the computer 7 in any suitable manner, for example in paper or preferably in an electronic form directly to the organisation operating the cleaning processes or machines.

In FIG. 2 an embodiment of the system of FIG. 1 is shown, wherein the service centre computer 7 is programmed to provide a website 17 through a server 18 for example. It is of course also possible to use the computer 7 for providing the website 17. The server 18(or computer 7) is accessible through a network 19, for example the Internet, for the management operating the cleaning processes or machines by means of client computers 20. The link between management operating a number of local ware washing operations and the local sites is schematically indicated by a line 21, whereas the link between the local ware washing operations 1 and the service centre computer 7 is indicated by a dashed line 22. Of course, security is provided to guarantee that each organisation can access the process data of its own cleaning operations only. In this manner each organisation can obtain the most recent information on all its ware washing or any other cleaning operations allowing a very effective management. Up-to-date data is available for the client computers 20 at a substantially real-time basis. A comparative analysis between the several local operations using these data is possible in an easy manner. The website 17 preferably comprises a menu with a number of options for types of reports and data to be selected by the clients. It is noted that for example a standard browser program or a web enabled spreadsheet program can be used to obtain the reports and data from the website 17.

Through the website 17 the service centre computer 7 can provide a number of services to the organisations operating the cleaning processes, the data of which is forwarded from the local processing units 3 to the computer 7. The service centre computer 7 supports preferably a report archive, a searchable incident log file, and a database with all recorded data in exportable format providing information on cost, hygiene, activity, and run-time with a user-friendly database query. For example, by means of the menu the management can retrieve information from each of these items.

The website 17 further allows service employees for example by means of a lap top computer 23 to retrieve the same data on the operation of cleaning processes at any location independent on the location where the employees are. The computer 7 further supports the service employees to retrieve configuration data on the cleaning processes or machines, for example dosing pump settings. Moreover the service employees can change these configuration data if this would be required. In this manner the service employees can check at any location the operation of a cleaning process and change process configuration data if necessary. Of course security is provided to prevent unauthorised access to specific data and unauthorised changes in the processes. It is possible to create several levels of data access and access to changing facilities both for the service centre organisation and cleaning process organisations.

The system described allows the service centre to provide a trouble shooting service, wherein a machine operator at a local site can contact the service centre to ask for advice, support or the like. In that case, the service centre computer 7 can make a connection to the local processing unit 3 to obtain the most recent process data to check the operation of the washing machine 2. On the basis of this recent data, the service centre computer 7 can forward new commands to the processing unit 3 with for example new dosing pump configuration data. Of course, depending on the problems to be solved, employees of the service centre could provide advice to the machine operators or visit the local ware washing operation to resolve the problem.

As a further service, the data obtained by the service centre computer 7 can be analysed by experts at the service centre to find any patterns, trends or the like, which could indicate future incidents, mistakes by machine operators or the like. Depending on the type of analyses, specific algorithms could be provided for such purposes.

It is noted that the system described allows for a different type of charging costs of the cleaning operations to the customers. In a conventional data logging system, customers are charged through the cleaning agents they buy.

This means that the price of the cleaning agents includes not only the actual cost of the cleaning agent but also service costs and the like. The present system allows the organisation operating the service centre to charge in a more accurate manner the cost of the services actually provided to the customers. In this manner the organisation managing the cleaning operations can be provided with more accurate information on the cost involved in their complete operations. Separate costs can be indicated/charged on incidents reported and lifted, operational time of the ware washing machines, and the like.

It is a further advantage of the system described that the managing organisations can be provided with any type of cost accounting information. Cost information can be provided for example per hour, day or batch of cleaned ware. In this manner internal transparency in the organisation is significantly enhanced. Organisations operating cleaning processes for a number of customers can monitor the customer profitability and can charge different customers using the same machine in an easy and transparent manner.

The invention is not restricted to the above-described embodiments, which can be varied in a number of ways within the scope of the following claims.

1. Method for supplying management services from a service centre for a plurality of industrial cleaning processes or machines at remote sites and/or operated by different organisations, characterized by providing a local unit at each process or machine, said local unit being programmed to forward process/machine information with a process/machine identification to the service centre, processing the information received from the local units in a service centre computer to obtain management reports on the process or operation of the machines.

2. Method according to claim 1, wherein the reports show operating parameter data against reference parameter data.

3. Method according to claim 1, wherein the service centre computer is programmed to determine reference parameter data from the operating parameter data received.

4. Method according to claim 1, wherein the service centre computer is programmed to provide reports for comparing different processes or the operation of different machines of an organisation.

5. Method according to claim 1, wherein the process or machine operation should meet hygienic requirements, wherein the service centre computer is programmed to provide reports with parameter data determining the hygiene of the process or machine operation.

6. Method according to claim 1, wherein the data of the reports is analysed to optimize the processes or operation of the machines.

7. Method according to claim 1, wherein the reports are issued by the service centre computer preferably in electronic form directly to the organisation operating the corresponding processes or machines.

8. System for monitoring a plurality of industrial cleaning processes or machines operated by at least one organisation, each process or machine using a local unit with a plurality of sensors for sensing operating parameters of the process or machine, the sensors providing parameter dependent signals to the local unit, wherein the local unit stores the operating parameter data, characterized by a service centre computer operated by a service organisation at a location remote from the location(s) of the local units, wherein the service centre computer is programmed to make a connection to a local unit and to obtain operating parameter data from the local unit periodically, wherein the service centre computer is programmed to provide reports with operating parameter data of at least one process or machine against reference operating parameter data.

9. System according to claim 8, wherein local units located at different sites and/or operated by at least two organisations are programmed to connect to the service centre computer, wherein the service centre computer is programmed to provide reports with operating parameter data of processes or machines of the same organisation.

10. System according to claim 8, wherein the service centre computer is programmed to provide reports with parameter data determining the hygiene of the process.

11. System according to claim 8, wherein the data of the reports is used to optimize the operation of the process or machine.

12. System according to claim 8, wherein the service centre computer issues the reports preferably in electronic form directly to the organisation operating the corresponding processes or machines.

13. System according to claim 8, wherein each process or machine uses a plurality of operating devices for controlling the process or operation of the machine, wherein the service centre computer is programmed to send a control signal to a local unit, wherein the local unit is adapted to actuate an operating device to change an operating parameter.

14. System according to claim 8, wherein the service centre computer is programmed to provide reports with operating parameter data for analysing the operation of the process or machine, for example by comparison with standard operating parameter data.

15. System according to claim 8, wherein the service centre computer is programmed to provide a report for maintenance of the machine(s).

16. System according to claim 8, wherein the service centre computer is programmed to determine reference operating parameter data from the operating parameter data received.
